(19) United States
(12) Patent Application Publication
(10) Pub. No.: US 2010/0039263 A1
(43) Pub. Date: Feb. 18, 2010

(54) System and method for utilization of smart meter infrastructure

(76) Inventors: Christopher Way-Fung Chen, Carlsbad, CA (US); Michael Terence Mohn, San Diego, CA (US); Fatih Aybar, San Diego, CA (US); Saul Vasquez Lopez, Oxnard, CA (US); Wanzhu Stella Du, Irvine, CA (US); Nimit Kandarp Pandya, San Jose, CA (US)

Correspondence Address: HOWREY LLP - East, C/O IP DOCKETING DEPARTMENT, 2941 FAIRVIEW PARK DR, SUITE 200, FALLS CHURCH, VA, 22042-2924, US

(21) Appl. No.: 12/458,370

(22) Filed: Jul. 9, 2009

Related U.S. Application Data
(60) Provisional application No. 61/129,657, filed on Jul. 10, 2008.

(51) Int. Cl. G08B 13/14; G08B 5/22

(52) U.S. Cl. 340/572.1; 340/825.49

(57) ABSTRACT

A system and method for tracking household assets that takes advantage of a home area network and neighborhood smart meter infrastructure. The system uses an asset tracking module comprising a microcontroller unit, motion sensor unit, and communication unit may be registered to a home area network and attached to a household asset. A home management system may be used to track the location of the module and alert a user if the module is moved.

### BACKGROUND

As energy costs continue to rise, ways to save and use energy efficiently are becoming increasingly popular. One of those ways is the use of advanced, or “smart,” utility meters. These smart meters may help save energy by providing far more detailed information on energy consumption than a traditional utility meter.

A smart meter may also provide additional benefits by communicating with a utility company or other third party in order to provide utility monitoring, billing, etc. In some smart meters, the utility company or third party is not only provided information from the smart meter, but may be able to provide the smart meter with information as well. Smart meters may use their communication capabilities to perform such functions as real-time utility pricing, up to date utility cost information, etc.

Advanced Metering Infrastructures (AMI) are proliferating in utilities around the world. The increased savings and efficiency obtained by the use of smart meters has led to widespread usage of smart meters in many areas. In fact, in some areas, smart meters may be so prevalent so as to provide an entire infrastructure within a neighborhood community. These infrastructures will make Home Area Networks (HAN) widely available to utility customers. These HANs may use wireless (such as Zigbee) or wired (such as Power Line Carrier or Broadband over Power Line) technologies to transport signals. As the present invention shows, this infrastructure of untapped resources may provide additional consumer services. As they are currently used, smart meters are normally focused on a single household and on utility usage or rates. Such a focus means that the full capabilities of a smart meter infrastructure have not yet been fully realized.

Home alarm systems may allow users to track and monitor the location of household assets and pets. The range of these devices are normally limited within the household where such a tracking and alarm system is set up. Advanced tracking systems may use global satellite tracking to locate lost pets. However, the present invention takes advantage of a smart meter infrastructure set up throughout a neighborhood to provide a cost-effective system for tracking assets.

### SUMMARY OF THE INVENTION

The present invention relates generally to a system for tracking household assets that takes advantage of home area network and smart meter infrastructures in a neighborhood.

In one embodiment, an asset tracking module comprising a microcontroller unit, motion sensor unit, and communication unit may be registered to a home area network and attached to a household asset. A home management system may be used to track the location of the module and alert a user if the module is moved. In another embodiment, the asset tracking module may be used to determine the location of a pet that has been lost in a neighborhood.

These and other objects and advantages of the invention will be apparent from the following description, the accompanying drawings and the appended claims.

### BRIEF DESCRIPTION OF THE DRAWINGS

While the specification concludes with claims particularly point out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designated like parts through the Figures, wherein:

FIG. 1 illustrates a block diagram of an asset tracking module according to one embodiment of the present invention.

FIG. 2 illustrates a home area network including an asset tracking module according to one embodiment of the present invention.

FIG. 3 illustrates an exemplary method for using an asset tracking module according to one embodiment of the present invention to track a lost pet.

### DETAILED DESCRIPTION

The present invention enhances the ability of consumers to track assets and monitor and control remote sensors, devices, and appliances. Unlike prior art, the present invention is unique in its ability to perform data collection, control, and standardized communication between devices. In some embodiments, the present invention may entail both hardware which wirelessly connects smart meters, appliances, and assets (including pets and children) to a home area network (HAN), as well as software (for example a home management system [HMS]) which manages the information gathered by the hardware and combines it with user inputs to automatically control devices and send alerts. Some embodiments may have an HMS with a web interface that may allow users to program and monitor their energy use and asset condition/location easily from their home computers, wireless devices (cell phones, PDAs, etc.), and other forms of remote access. The present invention takes advantage of the infrastructure provided by usage of smart meters and integrates energy efficiency, asset management, and pet/child tracking into a single system and provides a unique value to consumers.

One aspect of the present invention is its use to track assets. An asset tracking module may be able to track assets by being attached to or embedded in valuable items such as keys, jewelry, keys, remote controls, other frequently misplaced or valuable items, and even pets. Such a tracking module may communicate with one or more home area networks and/or smart meters to help determine that asset's location. In some embodiments, location may be determined when the tracking module communicates with a fixed node on a home area network. With a simple web-based interface, a user may see a map of their home and the location of each item. Since the home area network infrastructure may be vast, with multiple home area networks covering entire neighborhoods, the ability to track items is not limited to a single home, but can be extended to within wireless range of a home or business with a home area network.

Customers could also use this module to detect theft or misuse, particularly outside of the home, if the module is moved without proper authorization. For example, a module registered to a HAN would be affixed to a valuable item such as a flat panel television or jewelry box or portable safe or other items the consumer wishes to track. Since these types of items normally remain in a static location, any movement may indicate improper use and a notification would be sent to the owner via instant messaging, automated voice message, and/or other means. This alert would enable the owner to quickly take action, such as notifying law enforcement, improving the ability to prevent the theft. A notification may also be sent to a security or monitoring company which may help consumers track items that have been misappropriated. By virtue of the fact that the present invention may be sold throughout an entire territory, region, or municipality, much of the area where a misplaced item may end up may be within wireless range of a home- or business-area network. Therefore, even if the theft is not stopped, recovery of stolen items is much more likely because the items can be located anytime they are within range of a home area network.

Another use of the present invention may be to train pets to avoid certain areas of the home by placing home area network-connected ultrasound alarms around a house. For this use, the pet would have a module embedded in its collar or otherwise attached. The module would communicate with the home area network to determine the pet's location. A web interface would allow pet owners to set zones in which the pet is allowed or not allowed. A Pet Management System (PMS) may then use data from the home area network and collar module to detect the pet's movement and set off an alarm when that movement violates set parameters. Outside the home this same collar device can be used for pet tracking. If a pet runs away or is lost, the present invention may be used to determine the pet's location. Since the present invention may be used near many homes and businesses, the pet may be located practically any place there are buildings. For this reason, this method of pet tracking may be more reliable than existing systems as well as being more cost efficient since the present invention does not use satellite or cellular networks. Similarly, children may also be tracked by the present invention with, for example, a bracelet that connects to the home area network infrastructure. Parents may then monitor their child's location around their neighborhood through a web interface.

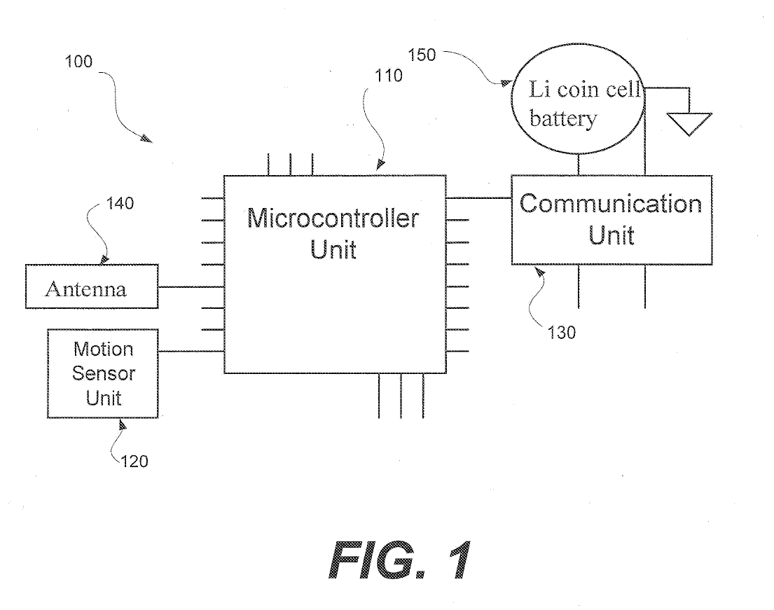

FIG. 1 illustrates a block diagram of an asset tracking module 100 according to one embodiment of the present invention. Asset tracking module 100 may include a microcontroller unit 110 serving as a location detection unit, motion sensor unit 120, communication unit 130, antenna 140, and battery 150. Microcontroller unit 110 may comprise a processor core, flash memory, analog-to-digital convertor, as well as several programmable input/output peripherals that are known in the art. The microcontroller unit 110 may serve as a location detection unit that processes data received from motion sensor 120 and antenna 140. The microcontroller unit may also transmit information to the communication unit 130.

In one embodiment, each asset tracking module 100 may include a unique identifier which is transmitted nearby nodes connected to the HAN. In addition to basic identity information, additional data, such as sensor data or battery voltage level, may also be transmitted. Communication unit 130 transmits data obtained from the microcontroller unit 110 wirelessly to the HAN. Many communication protocols may be integrated into the device, including but not limited to WiFi (802.15), ZigBee (802.15.4), WiMAX (802.16), Satellite, and RF. The transmitted signals may be detected by the smart meter and other nodes connected to the HAN. A home management system may use the signals received by smart meter and nodes to determine the location of the module through triangulation or any other method known in the art.

Motion sensor 120 detects motion and transmits data to the microcontroller unit 110. For example, motion sensor 120 may be an omni-directional tilt and vibration sensor with a small form factor and simple design that does not require calibration. Any other conventional component known in the art for detecting motion may also be used. In one embodiment, asset tracking modules may be used to detect theft of expensive items. For example, an asset tracking module 100 may be placed on expensive items around the home. If the motion sensor 120 detects movement, an interrupt signal may be sent to microcontroller unit 110 to determine the location and alert a user.

Motion sensor 120 may also be used to keep the module in sleep mode, when the microprocessor and communication unit are in a low state of activity so as to conserve power. Since communication unit 130 may use active RF signals to communicate with the HAN, sleep mode enables conservation of battery life to ensure that the module has enough power to communicate with the network. The use of motion sensor 120 to wake up the microprocessor unit 110 and communication unit 130 only when needed allows the module to have a very low duty cycle and reduced power consumption.

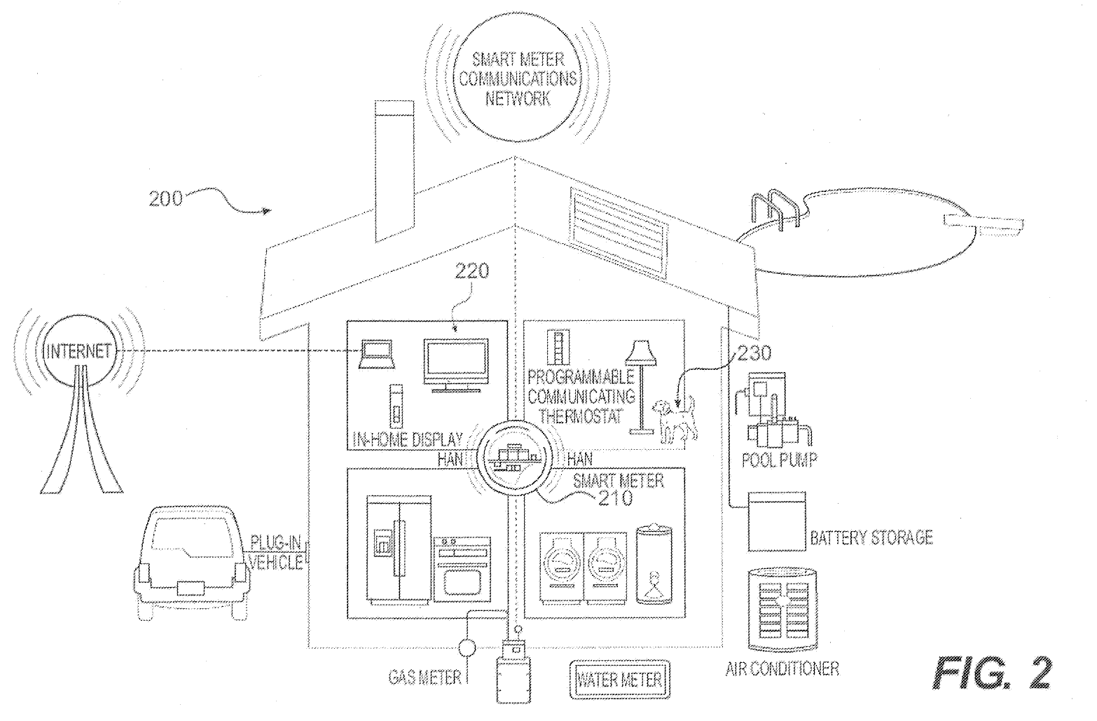

FIG. 2 illustrates a home area network including an asset tracking module according to one embodiment of the present invention. As shown in the figure, a HAN may be formed by connecting a smart meter 210 with various other devices in the house. Devices that are part of the HAN may include a programmable thermostat, gas meter, in home display, or any other device as would be known to one of skill in the art. These devices may communicate with smart meter 210 and each other using wireless protocols such as WiFi, ZigBee, WiMAX, or any other wireless technology known in the art. The smart meter may be connected to a smart meter communications network of smart meters in other households using AMI infrastructure.

In one embodiment of the present invention, an asset tracking module 100 may be placed on a valuable item inside the home, such as television 220, in order to detect possible theft of the item. An asset tracking module 100 could also be used in the collar of pet 230 to track the pet's location.

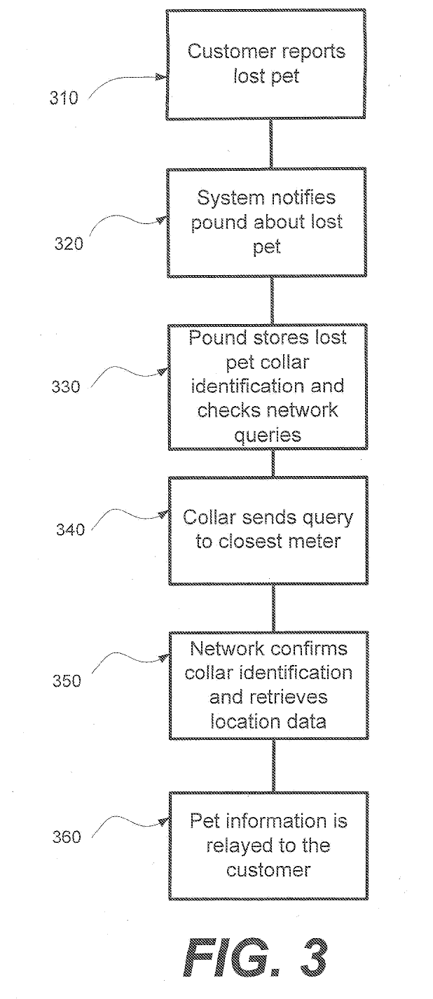

FIG. 3 illustrates a method for tracking a lost pet according to one embodiment of the present invention. Some embodiments of the invention allow for a pet tracking application using an asset tracking module. For example, a pet owner may fit his pet with a collar that includes an asset tracking module according to the present invention that is registered to the HAN. This device may verify its connection to the HAN to ensure that the pet is within the owner's premise. If the pet is lost, it is likely to be close to a smart meter or other HAN device in the neighborhood where it can be easily and reliably located through the HAN and AMI network. It may be possible to configure the system so as to avoid false notifications, for example, from times when pets are taken to the park for walks and are not lost. The system may be configured to notify an owner of a lost pet only during the night or when the owner specifically requests such information.

When a pet owner first discovers that the pet is lost, the owner may access a customer interface and report the lost pet as shown in step 310. Alternatively, the smart meter with which the pet's tracking module is registered may detect that the module is out of range and determine that the pet is lost. In step 320, an animal shelter or other public service may be notified of the lost pet through a neighborhood AMI network and provide authorization to perform a pet search. The animal shelter may store the identification information of the tracking module lost pet's collar in step 330. This information is compared to query information being transmitted on the HAN or AMI network. In step 340, the tracking module in the collar sends a “Lost” query to the nearest smart meter or other HAN device. This query is relayed by the smart meter through the neighborhood AMI network. The network may then confirm the tracking modules identification and determine the pet's location in step 350. Finally, the pet's location information may be communicated to the pet owner in step 360 so that the pet may be retrieved. The location information may also be relayed to the pound or other public service. Such a method may also be used to track children and/or other assets in the house.

In another embodiment, a pet collar fitted with an asset tracking module according to the present invention may be used to train a pet to avoid off-limit areas. For example, if the owner of a pet does not want the pet to go into certain rooms, these rooms may be equipped with HAN-connected ultrasound alarms that plug into free wall outlets. These alarms may search for a specified tracking module of a pet collar and set off the alarm if the module is found to be within a close range. Over time, these alarms may train the pet through conditioning to avoid certain areas of the house.

In another aspect, the invention may be used to help monitor, manage, and otherwise control energy usage and appliances within a location. In one embodiment, the invention uses many small, standardized devices that perform data collection, control, and standardized communication between appliances. By communicating with a home area network, these electrical devices may transfer information or be controlled remotely, in order to promote energy savings. Along those lines, standardized, low-power communicating hardware may be used in order to increase the effectiveness of one or more energy management systems. Moreover, such standardized, low-power hardware may be used to increase the effectiveness of a demand response (DR) energy management system.

In one or more embodiments of the invention, certain standardized technology is provided to appliance manufacturers. Appliance manufacturers may then integrate that standardized technology into their products and allow their products to communicate with other appliances and/or energy management systems. For example, home air conditioners, hot water heaters, and consumer appliances may all be equipped with this standardized technology. Using the home area network, then, these appliances may be controlled by and may, for example, be part of an effective demand response energy management system.

In some embodiments, the standardized technology may take the form of a cost-effective, pre-engineered module that is provided to appliance manufacturers. Such a module may then be connected to the appliance. Using such a connection, a module may cause the appliance to go into a low power state or turn on. Most energy efficiency and demand response-enabled appliances eventually approach a physical limit to the amount of energy they may conserve. However, appliances using this pre-engineered module may provide some market advantages. For instance, if lights or a television were left on in an empty room, then the motion detectors of a security system may utilize the present invention to send an “empty room” signal to the lights or television which may then turn off based on this information. The present invention may provide a type of dynamic energy budgeting by controlling and coordinating appliances. For example, the invention may direct a hot water heater to shutdown or lower its power consumption while an air conditioning unit starts up. The present invention, by using such features as the dynamic budgeting described above, may not only help conserve energy, but may help prevent events like brown outs, where energy is scarce as several households each with several appliances all attempt to use large amounts of energy at the same time. Also, these modules may enable display of usage and efficiency information that can help to increase consumer awareness and participation in demand response energy management. These modules may also be capable of performing sub-metering, energy budgeting, monitoring and control. Unlike the prior art, the present invention is capable of data collection, control, and standardized communication between devices. With the relatively little cost and effort needed to add pre-engineered modules to appliances and to allow them to communicate wirelessly, energy consumption effectiveness may be improved. Such an approach minimizes changes to existing infrastructure, since there is no hardwiring required between appliances and the system may utilize information from devices already existing in the home.

Similarly, the present invention allows utility customers to achieve energy savings without constant involvement after the system is in place and initially programmed. For example, the invention may allow users to specify a predetermined energy budget. The budget may be maintained by negotiating energy usage directly with appliances equipped with the pre-engineered modules. The present invention may perform data analysis and energy-efficiency learning and determine energy thresholds based upon the budget. That information may be sent to appliances via the pre-engineered modules. Based on, for example, determined thresholds, appliance priorities set by the user, and direct data from other devices, appliance modules may be instructed to take appropriate action (e.g. partial or complete shut down of the appliance or shift to lower power cycles). In this way there is no further customer interaction required (such as turning appliances on or off) to achieve energy savings once the budget is set. In addition, this module can support features such as real-time temperature readings for improved HVAC systems. Another feature of the present invention is monitoring and maintenance. Every connected appliance may be monitored for its power usage (indicating efficiency of operation) or malfunction. In this way, customers can choose to be alerted to potential appliance issues by their utility providers or they can monitor the condition of their appliances themselves using the present invention.

The subject matter of this disclosure may be embodied in many different forms and should not be construed as being limited to the embodiments set forth herein.

What is claimed is:

1. An asset tracking system comprising:
an asset tracking module; and
a network infrastructure;
wherein said asset tracking module comprises a microcontroller unit, a motion sensor unit, and a communication unit for transmitting a signal to nodes on the network infrastructure.

2. The asset tracking system of claim 1 wherein said network infrastructure is a home area network.

3. The asset tracking system of claim 2 wherein said home area network comprises advanced metering infrastructure smart meter.

4. The asset tracking system of claim 1 wherein the location of the asset tracking module is determined by analyzing the signal received by the nodes on the network infrastructure.

5. An asset tracking module comprising:
a communication unit for transmitting a signal to nodes on a network infrastructure;
a microcontroller; and
a motion sensor for detecting movement of the module.

6. The asset tracking module of claim 5 wherein said communication unit transmits a signal to a home area network.

7. The asset tracking module of claim 5 wherein said location detection unit and said communication unit are in sleep mode when no motion is detected by the motion sensor.

8. A method for tracking a lost asset comprising the steps of:
receiving lost asset identification information through a network infrastructure;
checking the network infrastructure for a lost asset signal;
confirming that lost asset signal matches lost pet identification information; and
reporting location of lost asset to a user;
wherein said lost asset signal is detected by a device on the network infrastructure.

9. The method for tracking a lost asset of claim 8 wherein said network infrastructure is a home area network.

10. A method for detecting theft comprising the steps of:
registering identity with a network infrastructure;
detecting motion; and
transmitting theft alert to the network infrastructure;
wherein said network infrastructure is a home area network.
